(19) United States
(12) Patent Application Publication
(10) Pub. No.: US 2009/0025080 A1
(43) Pub. Date: Jan. 22, 2009

(54) SYSTEM AND METHOD FOR AUTHENTICATING A CLIENT TO A SERVER VIA AN IPSEC VPN AND FACILITATING A SECURE MIGRATION TO SSL VPN REMOTE ACCESS

(76) Inventors: Craig Lund, Irvine, CA (US); Garret Grajek, Huntington Beach, CA (US); Stephen Moore, Portland, OR (US); Mark Lambiase, Ladera Ranch, CA (US)

Correspondence Address: STETINA BRUNDA GARRED & BRUCKER, 75 ENTERPRISE, SUITE 250, ALISO VIEJO, CA, 92656, US

(21) Appl. No.: 12/212,959

(22) Filed: Sep. 18, 2008

Related U.S. Application Data
(63) Continuation-in-part of application No. 11/880,599, filed on Jul. 23, 2007.
Application No. 11/880,599 is a continuation-in-part of application No. 11/702,371, filed on Feb. 5, 2007.
(60) Provisional application No. 60/827,118, filed on Sep. 27, 2006.

(51) Int. Cl. H04L 29/06

(52) U.S. Cl. 726/15

(57) ABSTRACT

Authenticating a client to a server accessible through an Internet Protocol Security (IPSec) Virtual Private Network (VPN) appliance. The IPSec VPN appliance and an SSL VPN appliance are configured to receive an initialization command from the client. The SSL VPN appliance is in communication with an authentication appliance for authenticating the client to the server. In response to the initialization command, the authentication appliance generates a client key pair including a client private key and a client public key. The authentication appliance generates a client certificate and a client IPSec profile. The authentication appliance transmits the client key pair, the client certificate and the client IPSec profile to the client. A secure communication session between the client and the server is established. The secure communication session is established through the IPSec VPN appliance. Upon receipt of the IPSec profile, the communication session between the client and the server is encrypted.

### CROSS-REFERENCE TO RELATED APPLICATIONS

This application is a continuation-in-part of, and claims the benefit of, U.S. patent application Ser. No. 11/880,599, entitled SYSTEM AND METHOD FOR SECURED NETWORK ACCESS, filed on Jul. 23, 2007, which is a continuation-in-part of, and claims the benefit of, U.S. patent application Ser. No. 11/702,371, entitled SYSTEM AND METHOD FOR FACILITATING SECURE ONLINE TRANSACTIONS, filed on Feb. 5, 2007, which claims the benefit of U.S. Provisional Application No. 60/827,118 filed Sep. 27, 2006, entitled MULTI-FACTOR AUTHENTICATION INCS PRODUCT SECUREAUTH IS A UNIQUE TECHNOLOGY TO AUTHENTICATE USERS TO ONLINE IT RESOURCES. SECUREAUTH IS UNIQUE IN ITS ABILITY TO UTILIZE X509 CERTIFICATES, IN A NON-PHISHABLE MANNER, TO AUTHENTICATE AND IDENTIFY USERS WITHOUT FORCING AN ENTERPRISE TO HOST A PKI INFRASTRUCTURE. SPECIFICALLY MFAS UNIQUE INTELLECTUAL PROPERTY PROVIDES X509 SECURE AUTHENTICATION WITHOUT REQUIRING THE ENTERPRISE TO DEPLOY CLIENT-SIDE SSL, each of which is incorporated by reference herein.

### STATEMENT RE: FEDERALLY SPONSORED RESEARCH/DEVELOPMENT

Not Applicable

### BACKGROUND

1. Technical Field

The present invention generally relates to methods and systems for authentication in secure data communications. More particularly, the present invention relates to methods and systems for generating digital certificates for authenticating a client to a server via an IPsec VPN solution, and facilitating the transition from the IPsec VPN solution to an SSL VPN solution.

2. Related Art

At the most basic level, electronic transactions typically involve a server computer system and a client computer system communicating over a network. In this open network environment, the primary concern of data security is three-fold. First, the server must be assured that the client is what it asserts it is. Second, the client must be assured that the server is what it asserts it is. Third, any information being exchanged between a legitimate server and a legitimate client must not be intercepted or changed by any other computer systems on the network.

In the electronic banking setting, for example, the bank must authenticate the identity of the user accessing the banking server, so that transactions relating only to a particular customer are permitted, and that the user accessing the banking server is verified as the customer or someone given authority by the customer. The client must be ensured that the banking server is, indeed, the server operated by the bank, and not a similar one operated by a malicious entity. This is known as a phishing attack, where a fake server is made to resemble the legitimate server, and tricks the user into providing confidential information such as bank account numbers, social security numbers, passwords, and the like. Because confidential information is being transmitted over an open network, such information must be encrypted or otherwise rendered incomprehensible to any other system besides the client and the server. The open nature of the network renders computer systems susceptible to replay attacks, where a valid data transmission is intercepted and repeated later for fraudulent or malicious purposes. For example, passwords or other authentication information may be intercepted, and used later to gain access to sensitive information. Further, the information being transmitted on the network must not be modifiable, such as in the case of man-in-the-middle attacks. This involves an attacker reading, inserting and modifying data between a legitimate client and server with neither recognizing the compromised nature of the link.

Generally, these security considerations are of primary importance in all networking environments where sensitive and/or confidential data is being exchanged. Many business organizations currently utilize Virtual Private Networks (VPNs) for secure remote access via public networks such as the Internet to the organization's internal network resources. Without proper safeguards that prevent the above-described attacks, the security of the organization's data as well as the organization's customers' or clients' data may be compromised, leading to even greater losses than that affecting just one individual.

To authenticate the server computer system or other like networked resource, and to ensure that data transmissions are not intercepted, the Transport Layer Security (TLS) protocol is frequently utilized. TLS is a cryptographic protocol that provides data exchanges safe from eavesdropping, tampering, and forgery, and is often used for securing web browsing, e-mail, file transfers, and other such electronic transactions. More particularly, TLS operates on the protocol layers below application-layer protocols such as the HyperText Transfer Protocol (HTTP), File Transfer Protocol (FTP), Simple Mail Transfer Protocol (SMTP), but above the transport level protocols such as the Transmission Control Protocol (TCP) or the User Datagram Protocol (UDP). Various components of a public key infrastructure (PKI) conforming to the International Telecommunications Union—Telecommunications Standardization Sector (ITU-T) PKI standard X.509 are utilized in the TLS protocol.

TLS is commonly implemented only on a server-side basis, however, and only the server is authenticated. For example, when establishing a secure HyperText Transfer Protocol (HTTP) connection or a secure VPN connection from a client browser to a web server or other network resource, the client browser retrieves a digital certificate associated with the web server. The certificate, which contains the public key, is used by the browser to authenticate the identity of the web server or network resource, and to encrypt a session key transmitted back thereto for use in encrypting subsequent data. In order to ensure the legitimacy of the server certificate, it is signed by a Certification Authority (CA).

Generally, public key encryption involves a unique public/private key pair held by both the recipient and the sender. The private key of the sender is retained solely by the sender, and the private key of the recipient is retained solely by the recipient. The public key of the sender is distributed and is held by the recipient, and the public key of the recipient is also distributed and held by the sender. When transmitting a message, the sender's private key and the recipient's public key is used to encrypt the message. The message is decrypted by the recipient using the recipient's private key and the sender's public key. The recipient need not have a unique public/private key pair, however, and instead may utilize a one-time cipher.

Secure Sockets Layer (SSL) VPN is a technology that provides remote-access VPN capability, using the SSL function that is already built into a modern web browser. SSL VPN allows users from any Internet-enabled location to launch a web browser to establish remote-access VPN connections. The advantage of SSL VPN is its use of SSL protocol and its successor, TLS, to provide a secure connection between remote users and internal network resources. Unlike traditional IP Security (IPSec) remote-access VPN technology, which requires installation of IPSec client software on a client machine before a connection can be established, users typically do not need to install client software in order to use SSL VPN. Another SSL VPN advantage over IPSec VPN is its ease of use for end users. Different IPSec VPN vendors may have different implementation and configuration requirements. SSL VPN requires only a modern web browser. One SSL VPN advantage for end users is in the area of outbound connection security. In most environments, outbound Secure HTTP traffic, which is also based on SSL, is not blocked. This means that even if a particular local environment does not permit outbound IPSec VPN sessions, SSL VPN is likely free of such restriction.

IPSec VPN may be utilized to encrypt traffic between a client and a server. The encryption is accomplished by utilizing a shared password between the client and the server. Unfortunately, passwords are not a reliable method for encryption because of their vulnerability to being exposed. Furthermore, brute-force techniques involving the entry of every combination of letters, numbers, and symbols, as well as dictionary-based techniques, may further compromise the effectiveness of such authentication systems. Because passwords must be memorized, users often choose words that are easier to remember, making it more susceptible to defeat by means of dictionary attacks. On the other hand, the more complex the passwords are required to be, the more likely that the password will be written on something easily accessible, for both the legitimate and malicious user, in the vicinity of the computer.

In order for an application to be compatible with SSL, the application must be designed for SSL. As a result, a client utilizing an IPsec VPN solution is not configured for SSL VPN remote access. An organization seeking to transition their clients over to an SSL VPN authentication solution must redeploy authentication credentials. However, the enterprises using SSL VPN solutions do not want to alienate clients still utilizing IPSec VPN solutions. At the same time, when the client is ready or decides to transition from an IPSec VPN solution to an SSL VPN solution, it is in the interest of the enterprise to seamlessly transition the client. The advantage in avoiding redeployment of authentication credentials is administrative cost savings and increased user functionality.

Accordingly, there is a need in the art for a method and system for authenticating the client to a network resource such as a web server, VPN links, and the like without the use of hardware devices or the deployment of client-side TLS. There is also a need for such authentication to be compatible with IPSec VPN and SSL VPN solutions. Furthermore, there is a need for facilitating a secure migration from IPSec VPN solutions to SSL VPN solutions for remote access without requiring the redeployment of authentication credentials.

### BRIEF SUMMARY

In accordance with one embodiment of the present invention, there is provided a method for authenticating a client to a server. The server is accessible through an Internet Protocol Security (IPSec) Virtual Private Network (VPN) appliance. The method begins with receiving on the IPSec VPN appliance an initialization command from the client. Additionally, the initialization command from the client is received on the SSL VPN appliance. It is contemplated that both the SSL VPN appliance and the IPSec VPN appliance receive the initialization command simultaneously. The SSL VPN appliance is in communication with an authentication appliance for authenticating the client to the server. In response to the initialization command, the method continues with generating a client key pair including a client private key and a client public key. Further, the authentication appliance generates a client certificate and a client IPSec profile. The authentication appliance transmits the client key pair, the client certificate and the client IPSec profile to the client. The method may continue with establishing a secure communication session between the client and the server. The secure communication session is established through the IPSec VPN appliance. In particular, the IPSec VPN appliance is configured to receive the IPSec profile from the client. Upon receipt of the IPSec profile, the communication session between the client and the server is encrypted.

An aspect of the present invention contemplates the secure communication session established between the client and the server is established via the SSL VPN appliance utilizing the client key pair and the client certificate that were generated when the secure communication was established via the IPSec VPN appliance. In this regard, it is contemplated that the client is using SSL VPN access rather than IPSec VPN access.

In another embodiment of the present invention, the client is authenticated to the server accessible through the IPSec VPN appliance with a challenge-response sequence specific to the server. Prior to establishing the secure communication session between the client and the server, the method may include generating a certificate transfer instruction from the SSL VPN appliance to the authentication appliance. This is only contemplated where the client lacks the sufficient client certificate. The client is then authenticated with a primary challenge-response sequence and the authentication appliance issues the client certificate and a corresponding client private key. It is contemplated that the primary challenge-response sequence is transmitted out-of-band to a predetermined data communication device independent of the client and associated with a user of the client. The response to the primary challenge-response sequence is transmitted out-of-band to a predetermined e-mail address associated with a user of the client. The response to the primary challenge-response sequence is predefined by a user of the client. Prior to issuing the client certificate, the client may be authenticated with a secondary challenge-response sequence associated with the server.

According to another embodiment of the present invention, there is provided a method of issuing a client certificate and a client IPSec profile for IPSec VPN access. The method may begin with receiving a login request from a client on an IPSec VPN appliance. Thereafter, a certificate transfer instruction may be generated from an SSL VPN appliance also configured to receive the login request from the client. The certificate transfer instruction is transmitted to an authentication appliance where the client lacks a pre-existing copy of the client certificate. The method may further include authenticating the client with a primary challenge-response sequence, in response to receiving the certificate transfer instruction from the SSL VPN appliance. An authoritative response to the primary challenge-response sequence may be deliverable through an out-of-band communications channel. The method may also include generating the client certificate, the client IPSec profile and a client private key, and transmitting the same to the client for storage and use. The method may conclude with establishing a secure communication session between the client and the server via the IPSec VPN appliance. The IPSec VPN appliance may be configured to receive the client IPSec profile for encryption of data transmitted between the client and the server.

In yet another embodiment of the present invention, there is provided a system for authenticating a client to a server accessible through an IPSec VPN appliance. The system may include an SSL VPN appliance for receiving an initialization command from the client. The system may also include an authentication appliance in communication with the SSL VPN appliance and the client. It is contemplated that the authentication appliance issues a client certificate, a client IPSec profile and a client private key to the client upon a successful authentication of the same. The system includes an IPSec VPN appliance configured to receive the client IPSec profile from the client. In response to receiving the IPSec profile on the IPSec VPN appliance, a communication session between the client and the server is encrypted. Thus, the client IPSec profile generated on the authentication appliance in communication with the SSL VPN appliance is utilized to encrypt communications between the client and the server accessible through the IPSec VPN appliance.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram illustrating an environment in which one aspect of the present invention may be implemented, including various interconnected servers, clients and Virtual Private Networks (VPNs);

FIG. 2 is a flowchart illustrating a method for authenticating a client to a server in accordance with an aspect of the present invention;

FIG. 3 is a prior art configuration illustrating the authentication of the client to the server via an IPSec VPN appliance;

FIG. 4 is an exemplary configuration of the authentication of the client via an IPSec VPN appliance utilizing client credentials associated with an SSL VPN appliance; and

FIG. 5 is an exemplary configuration of the secure migration from the IPSec VPN appliance to the SSL VPN appliance.

Common reference numerals are used throughout the drawings and the detailed description to indicate the same elements.

### DETAILED DESCRIPTION

The detailed description set forth below in connection with the appended drawings is intended as a description of an embodiment of the present invention, and is not intended to represent the only form in which the present invention may be constructed or utilized. The description sets forth the functions and the sequence of steps for developing and operating the invention in connection with the illustrated embodiment. It is to be understood, however, that the same or equivalent functions and sequences may be accomplished by different embodiments that are also intended to be encompassed within the spirit and scope of the invention. It is further understood that the use of relational terms such as first and second, and the like are used solely to distinguish one from another entity without necessarily requiring or implying any actual such relationship or order between such entities.

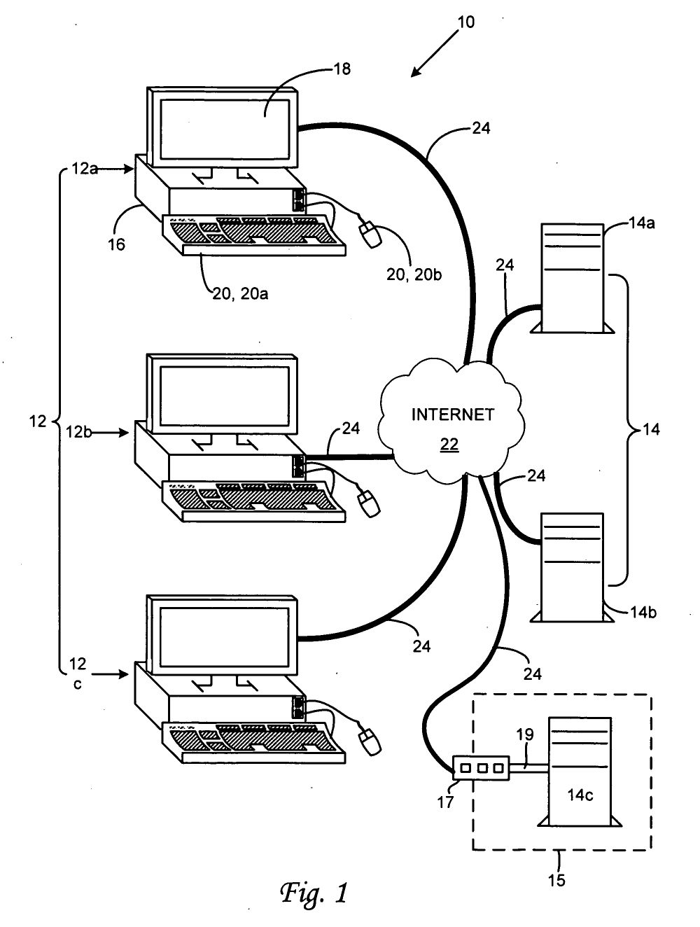

With reference to FIG. 1, an exemplary computer network 10 includes various data processing apparatuses or computers 12, 14. More particularly, the computers 12 may be personal computers or workstations that function as clients, and include a system unit 16 that houses a central processing unit, storage devices, and the like. The computers 12 may also include a display unit 18, and input devices 20 such as a keyboard 20a and a mouse 20b. It is understood that the system unit 16 receives various inputs from the input devices 20 that alter the control and flow of preprogrammed instructions being executed by the central processing unit, and the results of such execution are shown on the display unit 18. The computers 14 may be servers that provide data or services to the client computers 12. In this regard, the term “client” is understood to refer to the role of the computers 12 as a requester of data or services, while the term “server” is understood to refer to the role of the servers 14 to provide such data or services. Additionally, it is possible that the computers 12 may request data or services in one transaction and provide data or services in a transaction, thus changing its role from client to server or vice versa. It is further understood that the term “server” as utilized herein may also refer generally to networked services such as an Internet Protocol Security (IPSec) and a Secure Sockets Layer/Transport Layer Security (SSL/TLS) Virtual Private Network (VPN), through which conventional servers 14 provide data and applications to remote clients.

The computers 12, 14 are connected to a wide area network such as the Internet 22 via network connections 24. Requests from the client computers 12 and requested data from the server computers 14 are delivered through the network connections 24. According to an embodiment of the present invention, the server computers 14 are web servers, and the client computers 12 include web browsing applications such as Microsoft Internet Explorer that visually renders documents provided by the server computers 14 on the display unit 18. It will be appreciated that the network topology shown in FIG. 1 is presented by way of example only and not of limitation, and any other type of local or wide area network may be readily substituted without departing from the scope of the present invention. It is understood that any well known data transmission protocol may be utilized for the network connections 24 and the Internet 22.

A first server computer 14a may be a web server that provides account information Additional uses are also contemplated, where the first server computer 14a hosts a mail server, an online shopping site, or a Microsoft .NET application. A user 30 on the first client computer 12a may log on to first server computer 14a to retrieve information from the account using a web browser. In this exemplary context, one of the considerations of information security includes ensuring that the user 30 on the first client computer 12a is who he asserts to be. For example, a malicious user on a second client computer 12b may have all of the credentials of the user on the first client computer 12a to log on to the first server computer 14a without recognizing that such access is fraudulent. Another consideration is ensuring that the first server computer 14a is under the control of an enterprise of which the user 30 on the first client computer 12a is a customer. It may be possible that the second server computer 14b is masquerading as the first server computer 14a in a phishing attempt, and the first client computer 12a may have been misdirected to the second server computer 14b. Additionally, all legitimate data transfers between the first client computer 12a and the first server computer 14a must not be intercepted by any of the other computers, including a third client computer 12c, the second client computer 12b, and the second server computer 14b.

As indicated above, instead of a specific server computer 14a, the clients 12 may access a VPN 15. The VPN 15 may be connected to the Internet 22 via a VPN appliance 17 for permitting remote access to the server 14. It is understood that the VPN appliance 17 is the only modality through which outside clients 12 may access a server 14c on a local network 19. The same security concerns noted above are equally applicable to the VPN 15, and thus it is contemplated that the methods and systems of the present invention may be implemented therefor, as will be described in further detail below.

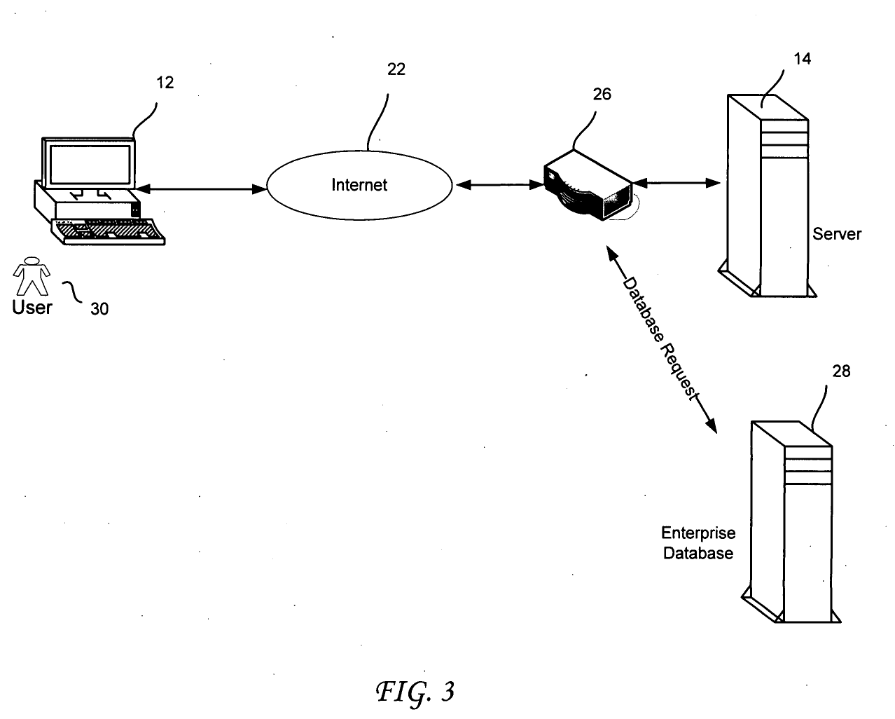

Referring to FIG. 3, the schematic provided is representative of a known method for authenticating the client 12 to the server 14 via an IPSec VPN appliance 26. The IPSec VPN appliance 26 is utilized to encrypt a communication session between the client 12 and the server 14. The user 30 associated with the client 12 transmits an initialization command over a network such as the Internet 22. The user 30 may initiate the authentication by having a certificate request identifier transmitted from the client computer 12 to the server computer 14 over an unsecured data link. However, prior to the transmission of the certificate request identifier, there may be an additional step of the client computer 12 initiating the unsecured connection with the server computer 14. For example, the user 30 may input the network address of the server computer 14 into the browser application on the client computer 12, at which point a request is made for a file or page on the server computer 14. The certificate request identifier is maintained on the server computer 14 to ensure that only transactions referenced by the certificate request identifier are deemed valid. According to one embodiment of the present invention, the certificate request identifier is accompanied by a certificate retrieval script, which directs the browser to begin the process of authenticating the client computer 12.

The initialization command is received on the IPSec VPN appliance 26. It is contemplated that the various IPSec VPN appliances that may be utilized include a VPN 3000 Concentrator, PIX Firewall, or various routers. The possible IPSec VPN appliances provided are by way of example only and not meant to limit the type of IPSec VPN appliance 26 that may be utilized. The IPSec VPN appliance 26 is used because the client 12 has software installed for VPN access via the IPSec VPN appliance 26. This is the case when the enterprise or organization associated with the client 12 prefers an IPSec VPN solution rather than an SSL VPN solution. Otherwise, if the client 12 utilized an SSL VPN solution, the IPSec VPN solution becomes redundant. In response to receiving the initialization command from the client 12, the IPSec VPN appliance 26 may request the client 12 to provide login information. The login information may include a username and password. Alternatively, the login information may include a hardware or software token. The login information is a security measure to prevent unauthorized access. Once the login information is provided to the IPSec VPN appliance 26 a database request may be made. In this respect, the IPSec VPN appliance 26 is in communication with an enterprise database 28. The enterprise database 28 may include the username and password or the token associated with the user 30 of the client 12. Thus, the IPSec VPN appliance 26 accesses the enterprise database 28 to verify that the correct username and password or token was provided by the user 30 of the client 12. If the information provided by the user 30 does not match then access to the server 14 is denied. If the information matches, the client 12 is authenticated to the server 14. Thus, the authentication of the client 12 to the server 14 and encryption of the communication session is established using a shared password.

The authentication of the client 12 does not utilize an X.509 client certificate for authentication to the server 14 via the IPSec VPN appliance 26. X.509 client certificates are typically associated with an SSL VPN solution. As a result, the authentication established by the IPSec VPN appliance 26 is weak and vulnerable to attack. While an X.509 client certificate may be supported by the IPSec VPN appliance 26, the IPSec VPN appliance 26 is not configured to generate the X.509 client certificate and associated credentials for authentication of the client 12 to the server 14. Additionally, the client 12 utilizing the IPSec VPN appliance is not configured to utilize the X.509 client certificate for authentication and encryption. However, it is preferable to use the X.509 client certificate for authentication because of its various advantages.

The client 12 having software for IPSec VPN access utilizes authentication other than secure X.509 client certificate authentication. In addition to the authentication being insecure, the organization associated with the server 14 is also at risk with a shared authentication key being utilized for encryption. This means that even if the organization is utilizing tokens (hardware or software) for authentication, the encryption is still a mere password, and thus vulnerable to attack. Therefore, it is more secure to utilize the X.509 client certificate with respect to the IPSec VPN appliance 26 for authenticating the client 12 to the server 14. Additionally, the communication session between the client 12 and the server 14 should be encrypted using the X.509 client certificate rather than a shared password.

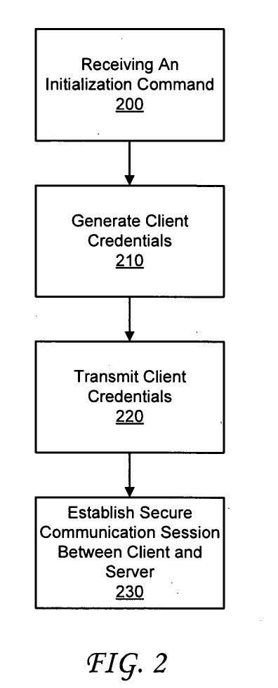

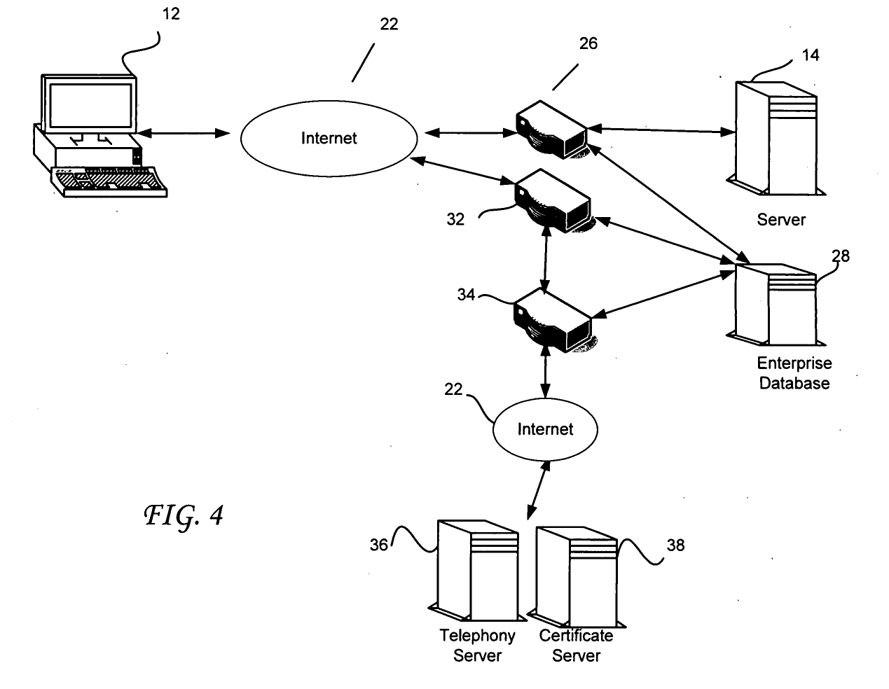

Referring now to FIG. 4, the diagram illustrates an embodiment of the present invention configured to authenticate the client 12 to the server 14 via the IPSec VPN appliance 26 utilizing the SSL VPN appliance 32 and an authentication appliance 34. FIG. 2, depicts the various steps utilized for authentication and encryption between the client 12 and the server 14 in accordance with the present invention. The first step contemplates receiving an initialization command 200. The initialization command is received on the IPSec VPN appliance 26 and the SSL VPN appliance 32. An aspect of the present invention contemplates receiving the initialization command from the client 12 over the Internet 22.

The advantage of adding the SSL VPN appliance 32, is that no additional software on the client 12 is required for access to the SSL VPN appliance 32. The user 30 may utilize a web browser already installed on the client 12 without having to install additional software for access to the SSL VPN appliance 32. This is a departure from the IPSec VPN appliance 26 wherein special software must be installed on the client 12. This now allows for using the X.509 client certificate for authentication and encryption via the IPSec VPN appliance 26 to the server 14 as will be described in further detail below.

Upon receiving the initialization command on the SSL VPN appliance 32, an X.509 certificate enrollment process may be initiated. The SSL VPN appliance 32 is in communication with an authentication appliance 34. It is contemplated that the authentication appliance 34 is a dedicated stand alone device. In another embodiment of the present invention, the authentication appliance 34 may be installed on the enterprise database 28 or a certificate server 38. The authentication appliance 34 is configured to generate a client certificate, a client private key, and a client public key (step 210). The key pair including the client private key and the client public key is associated with the client certificate which is used for authentication. Additionally, the authentication appliance 34 is configured to generate a client IPSec profile. The client IPSec profile is a file that instructs the client 12 how to communicate to the IPSec VPN appliance 26. The client IPSec profile generated by the authentication appliance 34 is instructed to utilize the same client private key and client public key that were used for authentication to be used to encrypt the communication session between the client 12 and the server 14. Thus, the communication session between the client 12 and the server 14 is individually encrypted with the client's private key. This results in a vast security improvement over both username/password and one-time passwords.

Authentication and encryption are both conducted after the user 30 associated with the client 12 has securely registered via the authentication workflow. Prior to issuing the client certificate and the client IPSec profile to the client computer 12, the user 30 associated therewith is authenticated via an out-of-band modality. According to one embodiment, the authentication appliance 34 notifies a telephony server 36 over the Internet 22 to deliver a one-time password to a cellular phone or a landline phone under the control of the user 30. Alternatively, an e-mail or a Short Message Service (SMS) text message may be sent. Other out-of-band authentication techniques are contemplated, such as voice recognition, IP address verification, and the like. The entry of the one-time password may be handled through the authentication appliance 34. In lieu of, or in addition to the foregoing out-of-band authentication, the user 30 may be presented with an additional knowledge-based authentication. For example, the user 30 may be asked about their favorite color, the high school they attended, and other similar questions. For this reason, the SSL VPN appliance 32 and the authentication appliance 34 are both in communication with the enterprise database 28. The enterprise database 28 may be used to store information associated with the user 30 of the client 12. Thus, the SSL VPN appliance 32 and the authentication appliance 34 may be configured to access the enterprise database 28 to ensure that the information received from the client 12 is correct.

Upon supplying the correct response, the authentication appliance 34 may direct the certificate server 38 to generate the client private key, the corresponding client certificate, and the client IPSec profile. The next step contemplates transmitting the client credentials 220 to the client 12 for storage thereon. The authentication appliance 34 is configured to store the client public key and the client private key where the IPSec VPN appliance 26 and the SSL VPN appliance 32 know where to find the key pair. This may include for example Microsoft keystore for Microsoft Internet Explorer, NSS keystore for Mozilla browsers, and Key Chain keystore for Apple Safari. The client certificate may contain both identification and authorization information. In order to identify the particular user 30, the user ID, first name, last name, and employee identification information such as employee number may be incorporated into the client certificate. Further, authorization data such as enterprise name, organization name, workgroup, and other group-based permission system data may be incorporated into the client certificate. Additional authentication information may be stored in the enterprise database 28 for later retrieval and use by the authentication appliance 34. It is understood that the foregoing procedure “registers” the browser on the client computer system 12 with the server computer 14, effectively making such browser a second authentication factor.

As indicated above, the authentication appliance 34 directs the telephony server 36 to deliver a one-time-password or authoritative response to a cellular phone, landline phone, or e-mail address previously known to be under the control of a user 30 of the client 12. The one-time-password is delivered over a communications modality that is independent of, or out-of-band with respect to, the data communication link between the client 12 and the IPSec VPN appliance 26 and the SSL VPN appliance 32. The telephony sever 36 may be managed by a third party, or by the organization that manages the VPN appliances 26, 32. The authentication appliance 34 directs the user 30 on the client 12 to enter the authoritative response. Along these lines, it is understood that the telephony server 36 and the step of transmitting the authoritative response to the client 12 may be omitted, where the authoritative response is an answer to a knowledge-based question. This answer is contemplated as being pre-defined by the user 30 at an earlier time.

Additionally, the authentication appliance 34 may query the server 14, to ensure that the client 12 has the authorization to access any resources thereon as a secondary authentication modality. It is contemplated that the server 14 has associated therewith its own username/password authentication scheme, and the authentication appliance 34 queries it. The server 14 may be an Active Directory server, a Lightweight Directory Access Protocol (LDAP) server, a database server, and so forth.

Upon successfully authenticating the client 12, the authentication appliance 34 directs the certificate server 38 to generate the client certificate, the client private key, and the client IPSec profile. The client certificate, the client private key, and the client IPSec profile are transmitted first to the authentication appliance 34, which transmits the same to the client 12 for storage thereon. The certificate server 38 may be hosted by a third party or by the enterprise that manages the VPN appliances 26, 32. According to one embodiment of the present invention, the authentication appliance 34 communicates with the certificate server 38 via a secured WSE 3.0 WebService call.

An aspect of the present invention contemplates the certificate server 38 as a Certificate Authority, and is understood to be within the control of a legitimate third party provider separate from the organization managing the server computer 14 and the enterprise database 28. In an alternative embodiment, the certificate server 38 and the telephony server 36 are managed and maintained by the same organization managing the server computer 14. In yet another embodiment, secure access is being enabled for web services. As understood, the term web service refers to a standardized system for supporting machine to machine interaction.

At step 230, the client 12 establishes a secure communication session with the server 14 via the IPSec VPN appliance 26. The client IPSec profile instructs the client 12 to utilize the client private key and the client public key to encrypt information transmitted between the client 12 and the server 14 over an open network. The key pair utilized is the same as used for authentication. Thus, the communication session between the client 12 and the server 14 is individually encrypted with the client private key.

The present invention also includes the ability to generate client credentials through user 30 self enrollment via the SSL VPN appliance 32 and the authentication appliance 34. The client credentials including the client IPSec profile are generated in response to receiving an access request from the client 12 via the SSL VPN appliance 32. This triggers the authentication workflow which may include authentication the client 12 via an out of band modality or knowledge based question. As a result, the client 12 receives the client credentials in response to user 30 registration and client 12 authentication. Therefore, the user 30 is now conducting secure bilateral X.509 authentication and encryption to the IPSec VPN appliance 26 with the client credentials generated by the SSL VPN appliance 32 and the authentication appliance 34. This is a vast security improvement over both username/password and one-time-passwords.

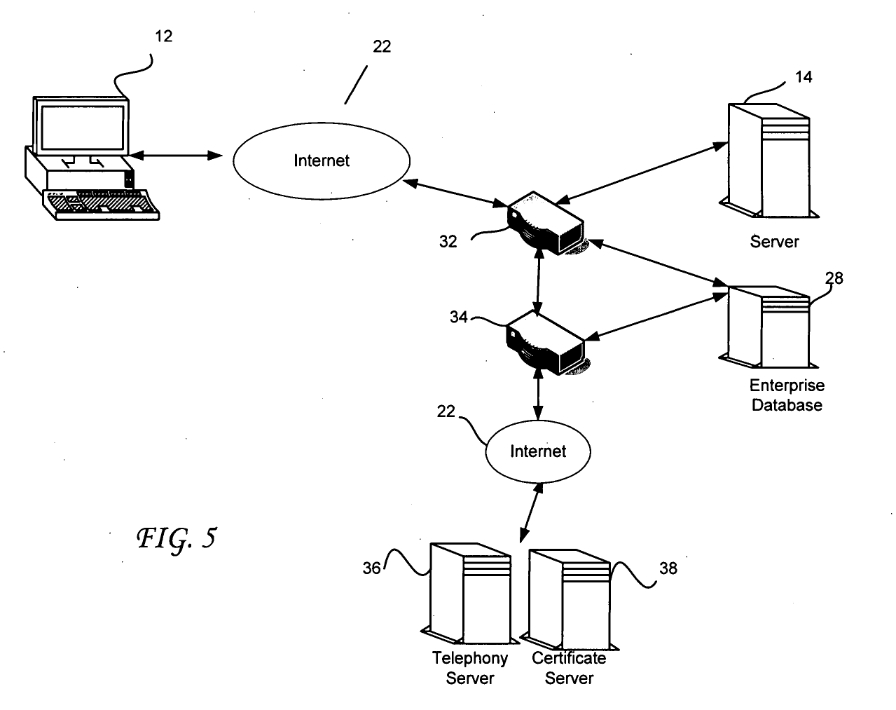

Referring now to FIG. 5, the illustration represents the transition from the client utilizing the IPSec VPN appliance 26 and the SSL VPN appliance 32 as provided in FIG. 4, to using the SSL VPN appliance 32 exclusively. In this step the organization or enterprise switches from an IPSec deployment to a full SSL VPN deployment. The same URL that was utilized to deploy the X.509 credential can now be utilized for the SSL VPN solution. In addition, the same X.509 client credentials issued by the authentication appliance 34 are utilized for authentication and encryption via the SSL VPN appliance 32. The advantage is, now users no longer need to have an IPSec compatible client. Additionally, the client IPSec profiles are no longer required on the client 12 to connect to the server 14. And because SSL VPN authentication is through the authentication appliance's secure X.509 registration system, which can utilize both SMS Text Messaging and Telephony OTPs for registration, the client 12 can be assured that the SSL VPN users are verified. Thus, this methodology facilitates the migration from traditional IPSec VPNs to the nimble and more user-friendly SSL VPN solutions.

In addition to the foregoing configurations, it is expressly contemplated that the authentication application 34 may be integrated into a wide variety of applications requiring bi-directional authentication. By way of example only and not of limitation, these include .NET forms authentication in .NET applications, Microsoft Outlook Web Access, and Microsoft Sharepoint, as well as any other system with enforcement points that require proper client and server authentication.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show any more detail than is necessary for the fundamental understanding of the present invention, the description taken with the drawings making apparent to those skilled in the art how the several forms of the present invention may be embodied in practice.

What is claimed is:

1. A method for authenticating a client to a server accessible through an Internet Protocol Security (IPSec) VPN appliance, the method comprising:
receiving on the IPSec VPN appliance and on an SSL VPN appliance an initialization command from the client;
generating a client key pair, a client certificate, and a client IPSec profile on an authentication appliance in response to receiving the initialization command on the SSL VPN appliance;
transmitting the client key pair, the client certificate, and the client IPSec profile to the client; and
establishing a secure communication session between the client and the server, the client IPSec profile being utilized to encrypt the communication session between the client and the server via the IPSec VPN appliance.

2. The method of claim 1, wherein the secure communication session is established between the client and the server via the SSL VPN appliance utilizing the client key pair and the client certificate.

3. The method of claim 1, wherein the client key pair includes a client private key and a client public key.

4. The method of claim 1, further comprising:
authenticating the client to the server accessible through the IPSec VPN appliance with a challenge-response sequence specific to the server.

5. The method of claim 1, wherein prior to establishing the secure communication session between the client and the server, the method includes:
generating a certificate transfer instruction from the SSL VPN appliance to the authentication appliance, wherein the client lacks the client certificate;
authenticating the client with a primary challenge-response sequence; and
issuing the client certificate and a corresponding client private key to the client from the authentication appliance.

6. The method of claim 5, wherein a response to the primary challenge-response sequence is transmitted out-of-band to a predetermined data communication device independent of the client and associated with a user of the client.

7. The method of claim 5, wherein a response to the primary challenge-response sequence is transmitted out-of-band to a predetermined e-mail address associated with a user of the client.

8. The method of claim 5, wherein a response to the primary challenge-response sequence is predefined by a user of the client.

9. The method of claim 5, wherein prior to issuing the client certificate, the method further includes:
authenticating the client with a secondary challenge-response sequence associated with the server accessible through the IPSec VPN appliance.

10. The method of claim 5, wherein prior to issuing the client certificate and the client key pair, the method includes:
generating the client certificate and the client key pair on an independent certificate authority server.

11. The method of claim 1, wherein the client key pair is installed in a keystore associated with a client browser.

12. A method of issuing a client certificate and a client IPSec profile for IPSec VPN access, the method comprising:
receiving a login request from a client on an IPSec VPN appliance;
generating a certificate transfer instruction from an SSL VPN appliance to an authentication appliance where the client lacks a pre-existing copy of the client certificate;
authenticating the client with a primary challenge-response sequence in response to receiving the certificate transfer instruction from the SSL VPN appliance, an authoritative response to the primary challenge-response sequence being deliverable through an out-of-band communications channel;
generating the client certificate, a client IPSec profile and a client private key;
transmitting the client certificate, the client IPSec profile and the client private key to the client; and
establishing a secure communication session between the client and a server via the IPSec VPN appliance, the IPSec VPN appliance configured to receive the client IPSec profile for encryption of data transmitted between the client and the server.

13. The method of claim 12, wherein the authoritative response is a one-time-password.

14. The method of claim 12, wherein the authoritative response is predefined according to knowledge particular to a user of the client.

15. The method of claim 12, wherein prior to generating the client certificate, the client IPSec profile and the client private key, the method further includes:
authenticating the client with a secondary challenge-response sequence associated with a server on the SSL VPN appliance.

16. A system for authenticating a client to a server accessible through an IPSec VPN appliance, the system comprising:
an SSL VPN appliance for receiving an initialization command from the client;
an authentication appliance in communication with the SSL VPN appliance and the client, for issuing a client certificate, a client IPSec profile and a client private key to the client upon a successful authentication thereof;
an IPSec VPN appliance configured to receive the client IPSec profile from the client;
wherein the IPSec VPN appliance encrypts a communication session between the client and the server utilizing the client IPSec profile.

17. The system of claim 16, further comprising:
an out-of-band authentication server for transmitting a challenge response to a communications device associated with a user of the client, the client being authenticated upon the challenge response being validated by the authentication appliance.

18. The system of claim 0, further comprising:
a server accessible through the IPSec VPN appliance, the client being validated against a secondary challenge-response sequence associated with an access control of the server.

19. The system of claim 16, further comprising:
a certificate authority server for generating the client certificate and the client private key.

20. The system of claim 16, further comprising:
a client authentication module associated with the client and including a memory for storing the client certificate, the client IPSec profile and the client private key, the client authentication module being in communication with the authentication appliance.

21. The system of claim 20, wherein the client authentication module is a browser-executable code downloaded from the authentication appliance.
